(19) United States
(12) Patent Application Publication
(10) Pub. No.: US 2021/0263325 A1
(43) Pub. Date: Aug. 26, 2021

(54) NON-CO-AXIAL ILLUMINATION FOR EYE TRACKING SYSTEM IN HEAD UP DISPLAY

(71) Applicant: Panasonic Automotive Systems Company of America, Division of Panasonic Corporation of North America, Peachtree City, GA (US)

(72) Inventor: LIANG YUAN, PEACHTREE CITY, GA (US)

(73) Assignee: Panasonic Automotive Systems Company of America, Division of Panasonic Corporation of North America

(21) Appl. No.: 17/159,856

(22) Filed: Jan. 27, 2021

Related U.S. Application Data
(60) Provisional application No. 62/979,113, filed on Feb. 20, 2020.

(51) Int. Cl. G02B 27/01; B60K 35/00

(52) U.S. Cl. CPC G02B 27/0179; G02B 2027/0181; G02B 2027/0187; B60K 35/00

(57) ABSTRACT

A head up display arrangement for a motor vehicle includes a picture generation unit emitting a light field including an image. Infrared illuminators each emit infrared energy in a respective non-parallel emission direction. A cold mirror is positioned to reflect the light field after the light field has been emitted by the picture generation unit, and to permit the infrared energy from each of the infrared illuminators to pass through the cold mirror. A second mirror is positioned to reflect both the light field and the infrared energy after the light field has been reflected by the cold mirror and after the infrared energy has been passed by the cold mirror, and before both the light field and the infrared energy have been reflected by a windshield such that a face of the driver reflects the infrared energy after it has been reflected by the windshield.

### CROSS-REFERENCED TO RELATED APPLICATIONS

This application claims benefit of U.S. Provisional Application No. 62/979,113 filed on Feb. 20, 2020, the disclosure of which is hereby incorporated by reference in its entirety for all purposes.

### BACKGROUND OF THE INVENTION

### 1. Field of the Invention

The present invention relates to a head up display (HUD) of a motor vehicle.

### 2. Description of the Related Art

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is directed up to the windshield and is then reflected from the windshield towards the driver. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

One kind of head up display (HUD) has an embedded eye tracking system (ETS) that is often operating at infrared (IR) wavelengths. A typical ETS reuses the optical pathway of the visible HUD display with a cold mirror to allow IR energy to be seen by a camera placed behind the mirror while having visible light reflected. The IR camera is usually installed in a direction whose axial direction is parallel with the gut ray (also called the optical axis ray, which is the ray on the optical axis of the HUD) of the visible optical pathway. The multiple LEDs necessary to provide sufficient illumination of the driver's face are usually installed with their optical axes all parallel to that of the camera as well as to the gut ray of the visible optical pathway.

One present limitation is that all illuminators use the same orientation angle, i.e., parallel to the visible-light axial-ray (also called gut ray), which actually does NOT provide the optimal illumination and brightness of the eye box (EB). Such use of the gut ray direction for illumination is not mandatory with respect to technical principles, but rather is often just a tradition.

FIG. 1 shows a schematic view of a traditional ETS HUD (windshield type) with all IR illuminators illuminating in one axial direction. The windshield and other curved optical surfaces account for the LEDs' illumination areas being shifted from each other. ETS HUD 100 has the ETS camera on the optical axis and multiple IR illuminators around the camera. The emission from different IR illuminators on the same IR part 102, especially the axial ray, joins the visible axial light ray from picture generation unit (PGU) 104 at the cold mirror 106, hits different areas on mirror 108 and is subsequently reflected on the windshield 112, and reaches the driver's face area 114. Thus, the driver can see a virtual image 116 ahead of the vehicle. The axial rays 120, 122, 124 that start from the center of the eye box reach the center of the IR camera. The freeform shape of windshield 112 as well as the curved mirrors 108 and potentially more optical surfaces with optical power may project rays from different illuminators into different areas of the driver's face. As shown in FIG. 1, two illuminators are installed in a way that their emission axes are shown as the multi-segment dotted lines 126 and 128. If the lateral displacement of the IR illuminator from the HUD optical axis is large enough, the illumination center could be significantly far away from the center of the eye box.

### SUMMARY OF THE INVENTION

The invention may provide a method, system and device for locating a user with multiple illuminators that supply illumination to a designated area. More specifically, the present invention may enable tracking a driver's location within a vehicle by using individually-designed illuminator installation properties for each of the multiple illuminators, especially using non-co-axial emission angles, to improve illumination over the driver's face and the eye box area.

The present invention enables each individual LED illuminator to have its own geometric properties, such as a unique position and angle of illumination. Thus, the illumination over the eye box area may be improved.

The invention comprises, in one form thereof, a head up display arrangement for a motor vehicle. The arrangement includes a picture generation unit emitting a light field containing an image. A plurality of infrared illuminators each emit infrared energy in a respective emission direction. The emission directions are non-parallel to each other. A cold mirror is positioned to reflect the light field after the light field has been emitted by the picture generation unit, and to permit the infrared energy from each of the infrared illuminators to pass through the cold mirror. A second mirror is positioned to reflect both the light field and the infrared energy after the light field has been reflected by the cold mirror and after the infrared energy has been passed by the cold mirror, and before both the light field and the infrared energy have been reflected by a windshield of the motor vehicle such that a human driver sees the image in the light field as a virtual image that appears to be outside of the windshield when eyes of the driver are in an imaginary eye box, and such that a face of the human driver reflects the infrared energy after the infrared energy has been reflected by the windshield.

The invention comprises, in another form thereof, a method of operating a head up display in a motor vehicle, including emitting a light field containing an image. Infrared energy is emitted from a plurality of locations. The infrared energy is emitted in a different emission direction from each of the locations. The emission directions are non-parallel to each other. The emitted light is reflected off of a cold mirror. The emitted infrared energy is passed through the cold mirror. Both the light field and the infrared energy are reflected off of a second mirror after the light field has been reflected by the cold mirror and after the infrared energy has passed through the cold mirror. Both the light field and the infrared energy are reflected off of a windshield of the motor vehicle such that a human driver sees the image in the light field as a virtual image that appears to be outside of the windshield when eyes of the driver are in an imaginary eye box, and such that a face of the human driver reflects the infrared energy after the infrared energy has been reflected by the windshield.

The invention comprises, in yet another form thereof, a head up display arrangement for a motor vehicle including a picture generation unit emitting a light field containing an image. A plurality of infrared illuminators each emit infrared energy. A cold mirror is positioned to reflect the light field after the light field has been emitted by the picture generation unit, and to permit the infrared energy from each of the infrared illuminators to pass through the cold mirror. A second mirror is positioned to reflect both the light field and the infrared energy after the light field has been reflected by the cold mirror and after the infrared energy has passed through the cold mirror, and before both the light field and the infrared energy have been reflected by a windshield of the motor vehicle such that a human driver sees the image in the light field as a virtual image that appears to be outside of the windshield when eyes of the driver are in an imaginary eye box, and such that the infrared energy converges after the infrared energy has been reflected by the windshield and as the infrared energy approaches a face of the human driver.

An advantage of the invention is that it helps to solve the problem of the driver's face appearing dark (or not sufficiently bright) in some existing HUD-based eye tracking systems (ETS).

Another advantage of the invention is that it enables the driver's face, which is a critical area to be seen by the eye-tracking camera, to be illuminated more brightly by providing each individual illuminator with unique properties such as emission orientation.

Yet another advantage of the invention is that it provides enhanced performance of the ETS without changing the illuminator component or increasing the power usage of the ETS.

A further advantage of the present invention is that it enables an ETS packaged in a HUD to function better by providing better illumination of driver's face using illuminators with different emission directions.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic side view of an eye tracking system (ETS) head up display arrangement of the prior art.

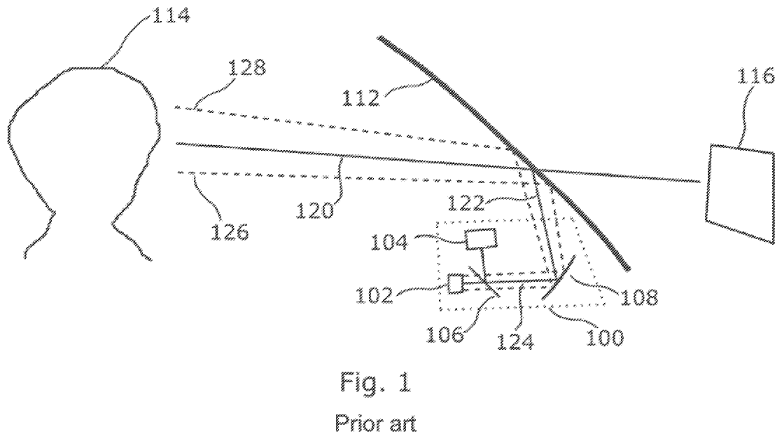

FIG. 2 is a schematic side view of one embodiment of an eye tracking system (ETS) head up display arrangement of the present invention.

FIG. 3 is an enlarged schematic side view of the IR part and IR-reflective mirror of the ETS head up display arrangement of FIG. 2.

FIG. 4 is a flow chart of one embodiment of a method of the present invention for operating a head up display in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

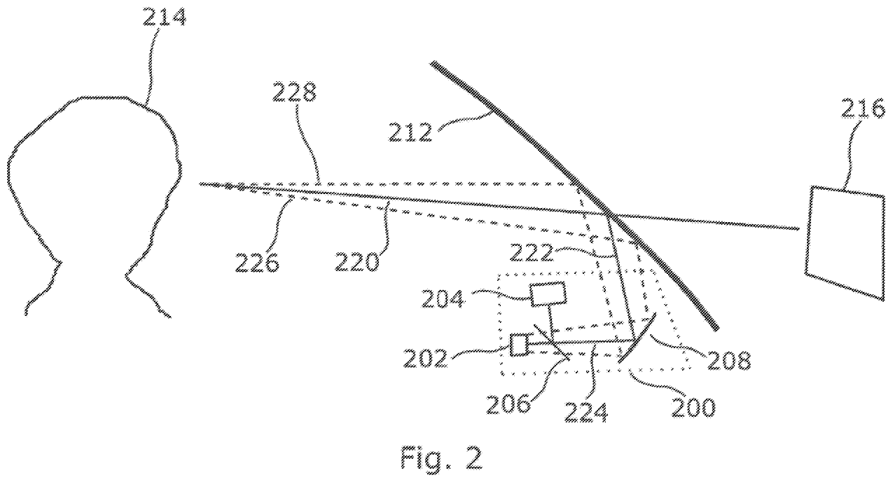

FIG. 2 illustrates one embodiment of an eye tracking system (ETS) head up display arrangement 200 of the present invention wherein an individual emitting direction is provided for each IR illuminator. The windshield and other curved optical surfaces may deliver an overlapped illumination center. HUD arrangement 200 has non-parallel ETS illuminator orientation angles such that all illuminators have their emission axes reaching the center of the eye box. The infrared emissions of the illuminators may converge after being reflected by the windshield and while approaching the face of the driver, and may be focused on the center of the eye box. The emissions from different IR illuminators within the same IR part 202, especially the axial ray, join the visible axial light ray from picture generation unit (PGU) 204 at the cold mirror 206, hit different areas on mirror 208 and are subsequently reflected on windshield 212, and reach the driver's face area 214. Thus, the driver can see a virtual image 216 ahead of the vehicle. The axial rays 220, 222, 224 that start from the center of the eye box may reach the center of the IR camera.

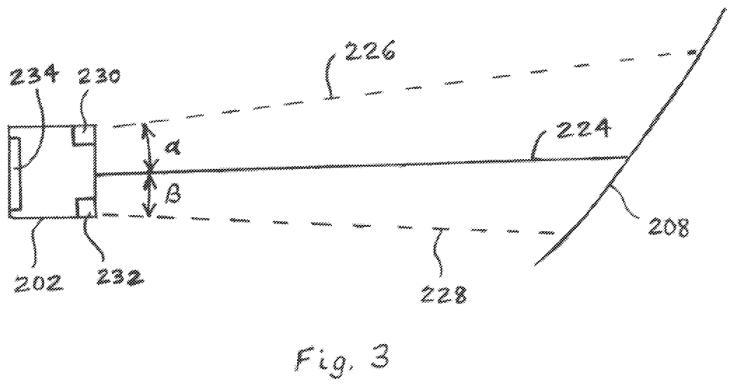

FIG. 3 is an enlarged view of IR part 202 and mirror 208. Cold mirror 206 is omitted from FIG. 3 for ease of illustration. As best shown in FIG. 3, IR part 202 includes two illuminators 230, 232 that are positioned such that their emission axes are non-parallel and diverge from each other and from axial ray 224. Thus, axial rays 226, 228 produced by respective IR illuminators 230, 232 simultaneously reach, and/or are focused upon, the center of the eye box, thereby providing improved illumination of the eye box. An angle α between axial rays 224, 226 may be greater than zero and less than thirty degrees. Similarly, an angle β between axial rays 224, 228 may be greater than zero and less than thirty degrees. An angle α+β between axial rays 226, 228 may be greater than zero and less than sixty degrees. In one embodiment, angle α+β is greater than one degree and less than ten degrees. Thus, the IR emission directions of illuminators 230, 232 may diverge from one another. IR illuminators 230, 232 may be disposed at diametrically opposed positions from each other relative to axial ray 224.

IR part 202 may also include an IR camera 234 that receives the IR energy from illuminators 230, 232 after the IR energy has been reflected back by the driver's face, windshield 212 and mirror 208.

In one embodiment, all illuminators are disposed on the same board (or surface). Asymmetric-profile lenses or custom lenses may be included in each illuminator to define a unique axial emission direction for that illuminator.

In another embodiment, all illuminators are disposed on the same board (or surface). Local modification may define a unique axial emission direction for each illuminator.

In yet another embodiment, every illuminator is on a single board. Thus, each illuminator may be installed in a different location and with a different orientation angle of emission.

In one further embodiment, different types of illuminators are provided with different optical properties such as field of view and profile. Each illuminator may be installed and disposed in a different location and with a different orientation angle of emission.

IR part 202 is shown as have two IR illuminators 230, 232. However, it is also within the scope of the invention for there to be any number of IR illuminators greater than two. The IR illuminators may be evenly spaced around a periphery of the IR part, and may each emit IR energy at a same angle that diverges from a common central axis, such as the common central axis represented by axial ray 224.

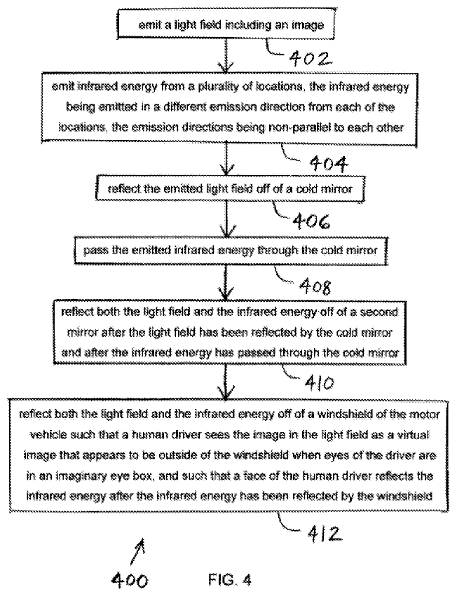

FIG. 4 illustrates one embodiment of a method 400 of the present invention for operating a head up display in a motor vehicle. In a first step 402, a light field including an image is emitted. For example, picture generation unit (PGU) 204 may emit a light field including an image.

Next, in step 404, infrared energy is emitted from a plurality of locations, the infrared energy being emitted in a different emission direction from each of the locations, the emission directions being non-parallel to each other. For example, IR energy may be emitted from two illuminators 230, 232 that are positioned such that their emission axes are non-parallel and diverge from each other and from axial ray 224.

In a next step 406, the emitted light field is reflected off of a cold mirror. For example, the light field from picture generation unit (PGU) 204 may be reflected by cold mirror 206.

In step 408, the emitted infrared energy is passed through the cold mirror. For example, the IR energy emitted from two illuminators 230, 232 may pass through cold mirror 206.

Next, in step 410, both the light field and the infrared energy are reflected off of a second mirror after the light field has been reflected by the cold mirror and after the infrared energy has passed through the cold mirror. For example, the light field from picture generation unit (PGU) 204 and the IR energy emitted from two illuminators 230, 232 may be reflected by mirror 208 after the light field has been reflected by cold mirror 206 and after the infrared energy has passed through cold mirror 206.

In a final step 412, both the light field and the infrared energy are reflected off of a windshield of the motor vehicle such that a human driver sees the image in the light field as a virtual image that appears to be outside of the windshield when eyes of the driver are in an imaginary eye box, and such that a face of the human driver reflects the infrared energy after the infrared energy has been reflected by the windshield. For example, the light field from picture generation unit (PGU) 204 and the IR energy emitted from two illuminators 230, 232 may be reflected by windshield 212 such that human driver 214 sees the image in the light field as a virtual image 216 that appears to be outside of the windshield 212 when eyes of driver 214 are in an imaginary eye box, and such that a face of human driver 214 reflects the infrared energy after the infrared energy has been reflected by windshield 212.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A head up display arrangement for a motor vehicle, the arrangement comprising:
a picture generation unit configured to emit a light field including an image;
a plurality of infrared illuminators each configured to emit infrared energy in a respective emission direction, the emission directions being non-parallel to each other;
a cold mirror positioned and configured to reflect the light field after the light field has been emitted by the picture generation unit, and to permit the infrared energy from each of the infrared illuminators to pass through the cold mirror; and
a second mirror positioned and configured to reflect both the light field and the infrared energy after the light field has been reflected by the cold mirror and after the infrared energy has passed through the cold mirror, and before both the light field and the infrared energy have been reflected by a windshield of the motor vehicle such that a human driver sees the image in the light field as a virtual image that appears to be outside of the windshield when eyes of the driver are in an imaginary eye box, and such that a face of the human driver reflects the infrared energy after the infrared energy has been reflected by the windshield.

2. The arrangement of claim 1, wherein the emission directions of the infrared illuminators diverge from one another.

3. The arrangement of claim 1, wherein the emission directions of the infrared illuminators diverge from one another at an angle that is greater than zero and less than sixty degrees.

4. The arrangement of claim 1, wherein the emission directions of the infrared illuminators diverge from one another at an angle that is greater than one degree and less than ten degrees.

5. The arrangement of claim 1, wherein the infrared energy from the infrared illuminators converges at a center of the eye box.

6. The arrangement of claim 1, wherein the infrared energy from the infrared illuminators is focused at a center of the eye box.

7. The arrangement of claim 1, further comprising an infrared camera positioned and configured to receive the infrared energy after the infrared energy has been reflected by the human driver's face.

8. A method of operating a head up display in a motor vehicle, the method comprising:
emitting a light field including an image;
emitting infrared energy from a plurality of locations, the infrared energy being emitted in a different emission direction from each of the locations, the emission directions being non-parallel to each other;
reflecting the emitted light field off of a cold mirror;
passing the emitted infrared energy through the cold mirror;
reflecting both the light field and the infrared energy off of a second mirror after the light field has been reflected by the cold mirror and after the infrared energy has passed through the cold mirror; and
reflecting both the light field and the infrared energy off of a windshield of the motor vehicle such that a human driver sees the image in the light field as a virtual image that appears to be outside of the windshield when eyes of the driver are in an imaginary eye box, and such that a face of the human driver reflects the infrared energy after the infrared energy has been reflected by the windshield.

9. The method of claim 8 wherein the emission directions diverge from one another.

10. The method of claim 8, wherein the emission directions diverge from one another at an angle that is greater than zero and less than sixty degrees.

11. The method of claim 8, wherein the emission directions diverge from one another at an angle that is greater than one degree and less than ten degrees.

12. The method of claim 8, wherein the infrared energy converges at a center of the eye box.

13. The method of claim 8, wherein the infrared energy is focused at a center of the eye box.

14. The method of claim 8, further comprising using an infrared camera to receive the infrared energy after the infrared energy has been reflected by the human driver's face.

15. A head up display arrangement for a motor vehicle, the arrangement comprising:
a picture generation unit configured to emit a light field including an image;
a plurality of infrared illuminators each configured to emit infrared energy;
a cold mirror positioned and configured to reflect the light field after the light field has been emitted by the picture generation unit, and to permit the infrared energy from each of the infrared illuminators to pass through the cold mirror; and
a second mirror positioned and configured to reflect both the light field and the infrared energy after the light field has been reflected by the cold mirror and after the infrared energy has passed through the cold mirror, and before both the light field and the infrared energy have been reflected by a windshield of the motor vehicle such that a human driver sees the image in the light field as a virtual image that appears to be outside of the windshield when eyes of the driver are in an imaginary eye box, and such that the infrared energy converges after the infrared energy has been reflected by the windshield and as the infrared energy approaches a face of the human driver.

16. The arrangement of claim 15, wherein emission directions in which the infrared illuminators emit the infrared energy diverge from one another.

17. The arrangement of claim 16, wherein the emission directions of the infrared illuminators diverge from one another at an angle that is greater than zero and less than sixty degrees.

18. The arrangement of claim 16, wherein the emission directions of the infrared illuminators diverge from one another at an angle that is greater than one degree and less than ten degrees.

19. The arrangement of claim 15, wherein the infrared energy from the infrared illuminators converges at a center of the eye box.

20. The arrangement of claim 15, wherein the infrared energy from the infrared illuminators is focused at a center of the eye box.

21. The arrangement of claim 15, further comprising an infrared camera positioned and configured to receive the infrared energy after the infrared energy has been reflected by the human driver's face.
